(19) United States
(12) Patent Application Publication
(10) Pub. No.: US 2025/0091689 A1
(43) Pub. Date: Mar. 20, 2025

(54) MODULAR CARGO VEHICLE

(71) Applicant: Magna International Europe GmbH, Wien (AT)

(72) Inventors: Mehmed BECIRBASIC, Behamberg (AT); Uwe SCHIMATZEK, Ansfelden (AT); Gerd SCHLAGER, Kefermarkt (AT)

(73) Assignee: Magna International Europe GmbH, Wien (AT)

(21) Appl. No.: 18/800,254

(22) Filed: Aug. 12, 2024

(30) Foreign Application Priority Data
Sep. 20, 2023 (EP) 23198426.1

(51) Int. Cl. B62K 27/00; B62D 63/06; B62K 7/04; B62K 13/04; B62K 13/06; B62K 13/08; B62K 19/40; B62M 6/60

(52) U.S. Cl. CPC B62K 27/003; B62D 63/062; B62K 7/04; B62K 13/04; B62K 13/06; B62K 13/08; B62K 19/40; B62M 6/60

(57) ABSTRACT

A modular cargo vehicle for transportation of cargo by a rider. The cargo vehicle includes a tow cycle, a front cargo module, and a trailer cargo module. The tow cycle has a rider seat, a front axle with a front wheel, a rear axle with one rear wheel, and a pedal crank to facilitate driving of the tow cycle by the rider via a pedal crank. A rear end of the front cargo module is coupled to a front end of the tow cycle. The front cargo module has a front axle with a front wheel, a cargo-receiving area, and no rear axle. A front end of the trailer cargo module is coupled to a rear end of the tow cycle. The trailer cargo module has a cargo-receiving area and an axially central axle with two wheels.

### CROSS-REFERENCE TO RELATED APPLICATIONS

The present application claims priority under 35 U.S.C. § 119 to European Patent Publication No. EP 23198426.1 (filed on Sep. 20, 2023), which is hereby incorporated by reference in its complete entirety.

### TECHNICAL FIELD

One or more embodiments of the present disclosure relates to a modular cargo vehicle for the transportation of cargo by a rider.

### BACKGROUND

It is known that a cycle, for example, with two or with three wheels (trike), can be used to transport cargo on a luggage rack. The cycle can be driven by a rider via a pedal crank. In addition or as an alternative, a cycle can be driven via an electric drive motor. Furthermore, a trailer can be coupled to a cycle in order to transport relatively large items of cargo.

What are known as scooters in English, in which the rider stands substantially upright on the stator and drives the vehicle without a pedal crank by pushing one foot against the ground, are also known. It is usually not possible to transport relatively large items of cargo on such scooters.

Motor vehicles are usually used for transporting relatively large items of cargo. Apart from the higher drive energy, however, motor vehicles also require wider access routes than cycles and scooters.

The use of a variety of transportation vehicles would be particularly efficient and economical, in particular, for delivery of an extremely wide range of goods by a delivery service, depending on the size and quantity of the goods.

A relatively large fleet with corresponding parking facilities, however, would have to be provided for this purpose. A large portion of the vehicles would then remain unused at any given time.

### SUMMARY

The object of the invention is to specify a modular cargo vehicle which can be used in a flexible manner and allows for efficient transportation of various quantities or sizes of goods in various environments.

The object is achieved by a modular cargo vehicle, for the transportation of cargo by a rider, the cargo vehicle comprising a tow cycle that itself comprises a front axle with a front wheel and a rear axle with one or two rear wheels, the tow cycle further comprising a rider seat, wherein the tow cycle can be driven by the rider by way of a pedal crank, wherein the cargo vehicle comprises a front cargo module, wherein the front cargo module and the tow cycle are designed such that the rear end of the front cargo module can be coupled to the front end of the tow cycle, wherein the front cargo module comprises a front axle with a front wheel and comprises a cargo-receiving area and does not comprise a rear axle, wherein the cargo vehicle comprises a trailer cargo module, wherein the trailer cargo module and the tow cycle are designed such that the front end of the trailer cargo module can be coupled to the rear end of the tow cycle, wherein the trailer cargo module comprises a, preferably axially central, axle with two wheels and comprises a cargo-receiving area.

In accordance with one or more embodiments, a tow cycle is used for the transportation of cargo, which tow cycle can be driven by a rider via a pedal crank, that is to say a cycle which can be driven by one person. The cycle may preferably be designed with three wheels, that is to say as a trike. This tow cycle has coupled to it both, at the rear, a trailer designed for this purpose and also, at the front, a front cargo module designed for this purpose, without their own rear axle. Both the front cargo module and the trailer cargo module serve to transport cargo, in particular goods, and therefore have cargo-receiving surfaces.

Within the scope of this document, the expressions “front”, “at the front” and “at the rear” relate to the usual direction of travel of the vehicle. Similarly, the expression “long” relates to the longitudinal extent of the vehicle, that is to say the x-direction, the extent from the front to the rear, which usually also corresponds to the direction of travel of the vehicle.

Developments of the invention are specified in the dependent claims, the description and the appended drawings.

Preferably, the tow cycle and the front cargo module are designed such that the front wheel of the front axle of the tow cycle is not in contact with the ground when the front cargo module is coupled to the tow cycle. The rear axle of the tow cycle can then be driven by way of the pedal crank. As an alternative, the rear wheel or rear wheels of the rear axle of the tow cycle are not in contact with the ground when the trailer cargo module is coupled to the tow cycle. The front axle of the tow cycle can then be driven by way of the pedal crank.

Preferably, the tow cycle has a drive battery and an electric drive motor and one axle of the tow cycle can be driven via the electric drive motor, preferably that axle of the tow cycle which can be driven via the pedal crank.

Preferably, the front cargo module has a drive battery and an electric drive motor and the front axle of the front cargo module can be driven via the electric motor.

Preferably, the trailer cargo module has a drive battery and an electric drive motor and the axle of the trailer cargo module can be driven via the electric drive motor.

Preferably, the tow cycle has a scooter mode, in which a standing surface of the tow cycle can be used, so that the rider can stand on the standing surface and can drive the tow cycle by pushing off from the road with one foot. The tow cycle preferably also has a cycle mode, in which the rider can use the rider seat and the pedal crank, so that the tow cycle can be driven like a conventional cycle by the rider by pedaling. In one embodiment of the invention, the rider seat and/or the pedal crank can be moved to a non-use position in the scooter mode, for example the rider seat and/or the pedal crank can be removed or folded away.

Preferably, the front cargo module is at least twice as long as the tow cycle and/or the trailer cargo module is at least twice as long as the tow cycle and/or the cargo-receiving area of the front cargo module is at least as long as the tow cycle, particularly preferably at least twice as long as the tow cycle. The tow cycle is therefore preferably of very short construction, preferably has a length of at most 1.3 meters or at most 1 meter from the front axle to the rear axle, so that it can also be used in extremely tight spaces without the front cargo module and without the trailer cargo module.

Preferably, the cargo vehicle is designed to be operated in the following modes: a tow cycle solo mode, a tow cycle solo scooter mode, a tow cycle front cargo module mode, a tow cycle front cargo module scooter mode, a tow cycle trailer cargo module mode, a tow cycle trailer cargo module scooter mode, a tow cycle front cargo module and trailer cargo module mode and/or a tow cycle front cargo module and trailer cargo module scooter mode.

### DRAWINGS

One or more embodiments of this disclosure will be illustrated by way of example in the drawings and explained in the description hereinbelow.

FIGS. 1A and 1B show schematic illustrations of a first embodiment of a tow cycle of a modular cargo vehicle in a tow cycle solo mode of operation (FIG. 1A) and a tow cycle solo scooter mode of operation (FIG. 1B).

FIGS. 2A and 2B show schematic illustrations of a second embodiment of a tow cycle of a modular cargo vehicle in a tow cycle solo mode of operation (FIG. 2A) and a tow cycle solo scooter mode of operation (FIG. 2B).

FIGS. 3A and 3B show schematic illustrations of a first embodiment of a tow cycle and a front cargo module of a modular cargo vehicle in a tow cycle front cargo module mode of operation (FIG. 3A) and a tow cycle front cargo module scooter mode of operation (FIG. 3B).

FIGS. 4A and 4B show schematic illustrations of a second embodiment of a tow cycle and a front cargo module of a modular cargo vehicle in a tow cycle front cargo module mode of operation (FIG. 4A) and a tow cycle front cargo module scooter mode of operation (FIG. 4B).

FIGS. 5A and 5B show schematic illustrations of a first embodiment of a tow cycle and a trailer cargo module of a modular cargo vehicle in a tow cycle trailer cargo module mode of operation (FIG. 5A) and a tow cycle trailer cargo module scooter mode of operation (FIG. 5B).

FIGS. 6A and 6B show schematic illustrations of a second embodiment of a tow cycle and a trailer cargo module of a modular cargo vehicle in a tow cycle trailer cargo module mode of operation (FIG. 6A) and a tow cycle trailer cargo module scooter mode of operation (FIG. 6B).

FIGS. 7A and 7B show schematic illustrations of a first embodiment of a modular cargo vehicle in a tow cycle front cargo module and trailer cargo module mode of operation (FIG. 7A) and a tow cycle front cargo module and trailer cargo module scooter mode of operation (FIG. 7B).

FIGS. 8A and 8B show schematic illustrations of a second embodiment of a modular cargo vehicle according to the invention in a tow cycle front cargo module and trailer cargo module mode of operation (FIG. 8A) and a tow cycle front cargo module and trailer cargo module scooter mode of operation (FIG. 8B).

FIG. 9 shows a schematic illustration of possible positions of drive batteries in a first embodiment of a modular cargo vehicle in the tow cycle front cargo module and trailer cargo module mode.

### DESCRIPTION

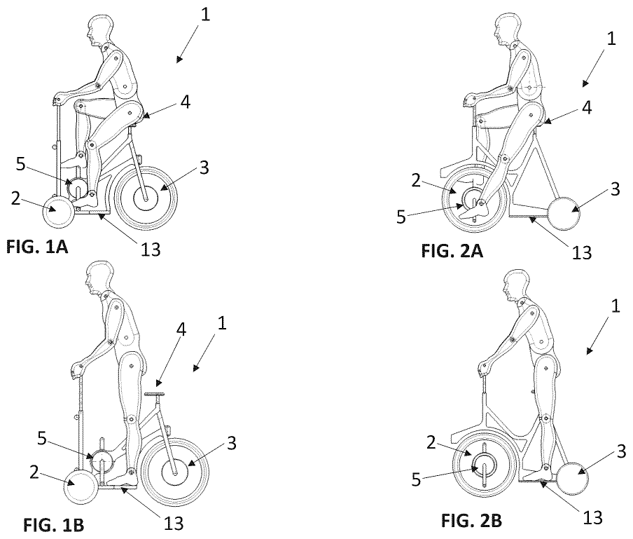

FIGS. 1A and 1B show a schematic illustration of a first embodiment of a tow cycle 1 of a modular cargo vehicle in accordance with one or more embodiments. In FIG. 1A, the rear axle, and therefore, the rear wheel 3 or the two rear wheels 3 of the tow cycle 1 are driven in a tow cycle solo mode of operation (FIG. 1a). In FIG. 1B, the rear axle, and therefore, the rear wheel 3 or the two rear wheels 3 of the tow cycle 1 are driven in a tow cycle solo scooter mode of operation. The same tow cycle 1 is therefore operated as a cycle (in FIG. 1A) specifically with the rider seated on a rider seat 4 and pedaling a pedal crank 5, and as a scooter (in FIG. 1B) specifically with the rider standing on a standing surface 13 and pushing off from the roadway with one foot. Preferably, the rear axle has two wheels 3 and the tow cycle 1 is therefore a trike. The tow cycle 1 comprises a front axle with a front wheel 2 and comprises a rear axle with one or, as mentioned, with two rear wheels 3.

As illustrated in FIGS. 2A and 2B, the pedal crank 5 of the tow cycle 1 can be designed to drive the front axle of the tow cycle 1 instead of the rear axle of the tow cycle 1 (FIGS. 1A and 1B). For this purpose, the pedal crank 5 can preferably be arranged directly on the front axle.

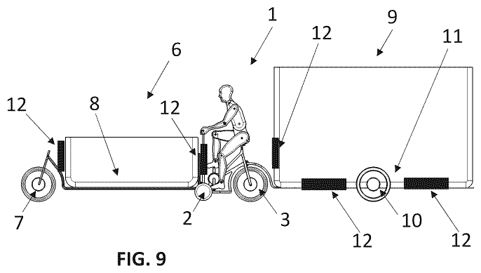

In addition to manual driving of the tow cycle 1 by the rider via the pedal crank 5, the tow cycle 1 can have a drive battery 12 and a drive motor (see FIG. 9). For example, the tow cycle 1 can be used for rapid transportation of relatively small quantities of goods on short and/or narrow routes. The tow cycle 1 can be a self-driving vehicle (tractor), for example, for delivering small goods. The tow cycle 1 can also serve to transport people.

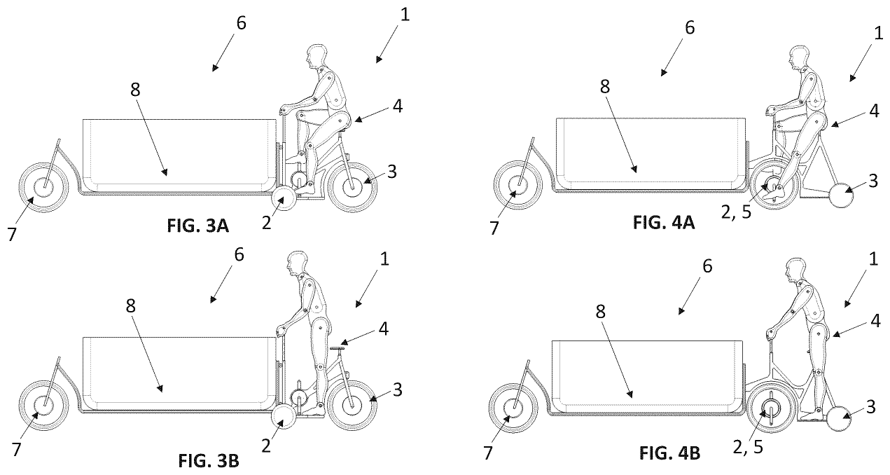

FIGS. 3A and 3B show a schematic illustration of a tow cycle 1 and a front cargo module 6 of a modular cargo vehicle in accordance with one or more embodiments in a tow cycle front cargo module mode of operation (FIG. 3A) and a tow cycle front cargo module scooter mode of operation (FIG. 3B). Here, the cargo vehicle comprises a front cargo module 6. The front cargo module 6 and the tow cycle 1 are designed such that the rear end of the front cargo module 6 can be coupled to the front end of the tow cycle 1.

The front cargo module 6 comprises a front axle with a front wheel 7 and comprises a cargo-receiving area 8. The cargo-receiving area 8 can have side walls and substantially form a container which is open or closeable at the top. The front cargo module 6 does not comprise a rear axle. The front cargo module 6 can have a drive battery 12 and an electric drive motor, and the front axle of the front cargo module 6 can be driven via the electric drive motor.

The front wheel 2 of the front axle of the tow cycle 1 can be designed to not be in contact with the ground when the front cargo module 6 is coupled to the tow cycle 1. The rear axle of the tow cycle 1 can then be driven by way of the pedal crank 5 and/or by way of a drive motor.

Owing to the ability to couple and uncouple a front cargo module 6, the cargo cycle can provide, for example, an advantage in respect of time: while a rider of a conventional cargo cycle has stopped for loading purposes, for example, an already loaded front part can be docked to a tow cycle 1 in order to immediately transport the goods. Battery charging times can also be reduced by docking a front cargo module 6 with a drive battery 12 that is already charged.

FIGS. 4A and 4B show a variant of the modular cargo vehicle of FIGS. 3A and 3B, but with the front wheel of the tow cycle 1 being driven as in FIGS. 2A and 2B.

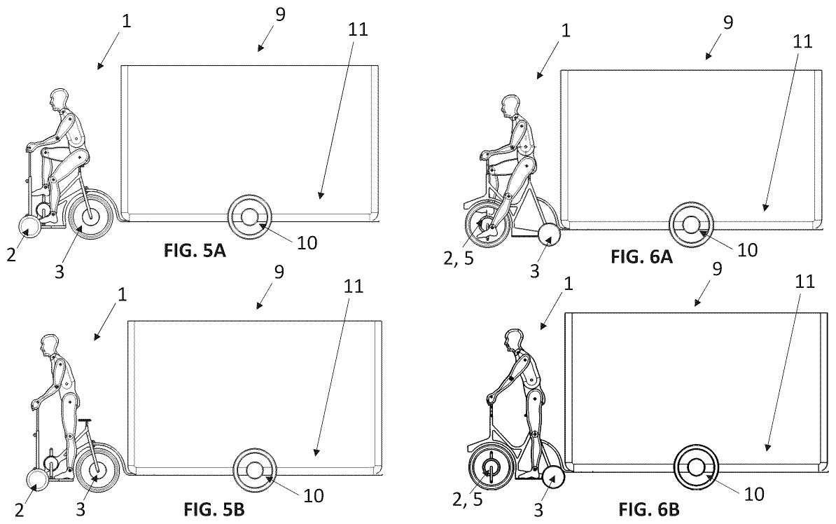

FIGS. 5A and 5B show a schematic illustration of a tow cycle 1 and a trailer cargo module 9 of a modular cargo vehicle in a tow cycle trailer cargo module mode of operation (FIG. 5a) and a tow cycle trailer cargo module scooter mode of operation (FIG. 5b). Here, the cargo vehicle comprises a trailer cargo module 9. The trailer cargo module 9 and the tow cycle 1 are designed such that the front end of the trailer cargo module 9 can be coupled to the rear end of the tow cycle 1.

The trailer cargo module 9 comprises a preferably axially approximately central axle with two wheels 10 and a cargo-receiving area 11. The cargo-receiving area 11 can have side walls and substantially form a container that is open or closeable at the top. The trailer cargo module 9 can have a drive battery 12, preferably a plurality of drive batteries 12, and an electric drive motor, and the axle of the trailer cargo module 9 can be drivable via the electric drive motor.

With the trailer cargo module 9, relatively large quantities of goods can be transported in this operating mode. The vehicle remains highly mobile at the same time.

In the embodiment according to FIGS. 6A and 6B, the front axle of the tow cycle 1 is not directly driven either. The rider again uses the same tow cycle in a seated manner in the upper figures (FIGS. 5A and 6A), i.e., in the cycle mode, and in a standing manner, i.e., in the scooter mode, in the lower figures (FIGS. 5B and 6B).

As illustrated in FIGS. 6A and 6B, the rear wheel or the rear wheels 3 of the rear axle of the tow cycle 1 can be designed such that they are not in contact with the ground when the trailer cargo module 9 is coupled to the tow cycle and the front axle of the tow cycle 1 can be driven by way of the pedal crank 5.

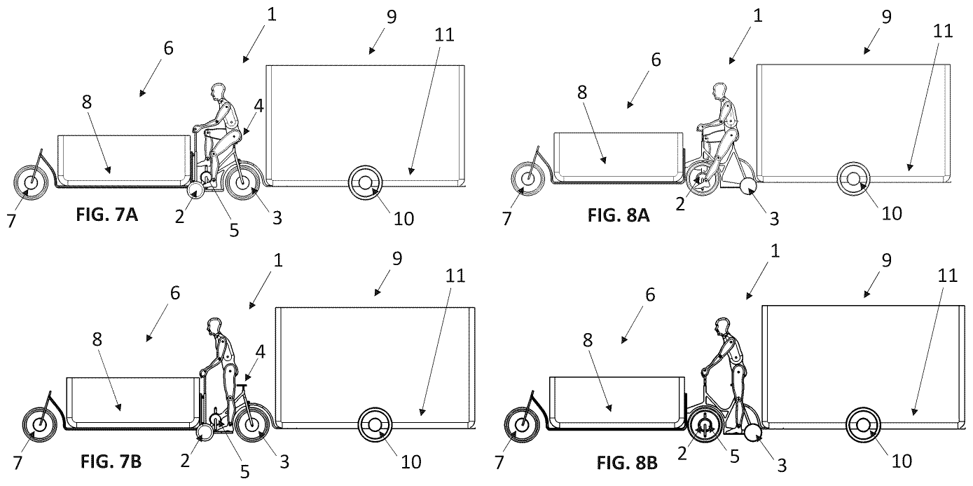

FIGS. 7A and 7B show a schematic illustration of an entire modular cargo vehicle in a tow cycle front cargo module and trailer cargo module mode of operation (FIG. 7a) and a tow cycle front cargo module and trailer cargo module scooter mode of operation (FIG. 7b). The cargo vehicle therefore comprises a tow cycle 1, a front cargo module 6, and a trailer cargo module 9. Relatively large quantities of goods can be transported in this state of the cargo vehicle.

A drive battery 12 can be placed in the front part of the cycle, in particular in the center, in order to render the individual components independent (see FIG. 9). With this complete configuration, the small wheels of the tow cycle 1 are preferably not in contact with the ground.

FIGS. 8A and 8B again shows a likewise complete vehicle as in FIGS. 7A and 7B, only with the front axle of the tow cycle 1 being driven, instead of the rear axle. The front cargo module 6 can be at least twice as long as the tow cycle 1. The trailer cargo module 9 can be at least twice as long as the tow cycle 1. The cargo-receiving area 8 of the front cargo module 6 can be longer than the tow cycle 1, preferably approximately twice as long. Such a modular cargo vehicle can therefore be operated in the modes illustrated in the previous figures (FIGS. 1A through 8A and FIGS. 1B through 8B) a tow cycle solo mode, a tow cycle solo scooter mode, a tow cycle front cargo module mode, a tow cycle front cargo module scooter mode, a tow cycle trailer cargo module mode, a tow cycle trailer cargo module scooter mode, a tow cycle front cargo module and trailer cargo module mode and/or a tow cycle front cargo module and trailer cargo module scooter mode.

FIG. 9 shows a schematic illustration of possible positions of drive batteries 12 in a first embodiment of a modular cargo vehicle in accordance with one or more embodiments in the tow cycle front cargo module and trailer cargo module mode. For example, a drive battery 12 can be arranged in the front cargo module 6, in particular in the region of the front end of the front cargo module 6. A further drive battery 12 can be arranged in the tow cycle 1, in particular in the region of the front end of the tow cycle 1. One or more drive batteries 12 can be installed in the trailer cargo module 9, for example on the cargo-receiving area 11, in front of and/or behind the axially central axle.

The cargo cycle can therefore have three main components:
A single-lane front carrier (front cargo module 6). For the high-load option, the front wheel can be equipped with a hub motor and a battery can be integrated.
Traction machine (tow cycle 1), preferably in the form of a trike with a V- or A-arrangement-one axle is electrically driven and the trike can be equipped with a small battery in order to be operated in a stand-alone mode.
Trailer (trailer cargo module 9): with or without driven hub motors and a battery.

### LIST OF REFERENCE SYMBOLS

1 Tow cycle
2 Front wheel of the tow cycle
3 Rear wheel of the tow cycle
4 Rider seat
5 Pedal crank
6 Front cargo module
7 Front wheel of the front cargo module
8 Cargo-receiving area of the front cargo module
9 Trailer cargo module
10 Wheels of the trailer cargo module
11 Cargo-receiving area of the trailer cargo module
12 Drive battery
13 Standing surface

What is claimed is:

1. A modular cargo vehicle for transportation of cargo by a rider, the modular cargo vehicle comprising:
a tow cycle having a rider seat, a front axle with a front wheel, a rear axle with one rear wheel, and a pedal crank to facilitate driving of the tow cycle by the rider via a pedal crank;
a front cargo module operatively connected to the tow cycle such that a rear end of the front cargo module is coupled to a front end of the tow cycle, the front cargo module having a front axle with a front wheel, a cargo-receiving area, and no rear axle; and
a trailer cargo module operatively connected to the tow cycle such that a front end of the trailer cargo module is coupled to a rear end of the tow cycle, the trailer cargo module having a cargo-receiving area and an axially central axle with two wheels.

2. The modular cargo vehicle of claim 1, wherein in an operating mode of the modular cargo vehicle in which the front cargo module is coupled to the tow cycle:
the front wheel of the front axle of the tow cycle is not in contact with a support surface, and
the rear axle of the tow cycle is driven via the pedal crank.

3. The modular cargo vehicle of claim 1, wherein in an operating mode of the modular cargo vehicle in which the front cargo module is coupled to the tow cycle:
the rear wheel of the rear axle of the tow cycle is not in contact with a support surface, and
the front axle of the tow cycle is driven via the pedal crank.

4. The modular cargo vehicle of claim 1, wherein the tow cycle further has a drive battery and an electric drive motor to drive the front axle or the rear axle.

5. The modular cargo vehicle of claim 1, wherein the front cargo module further has a drive battery and an electric drive motor to drive the front axle of the front cargo module.

6. The modular cargo vehicle of claim 1, wherein the trailer cargo module has a drive battery and an electric drive motor to drive the axially central axle of the trailer cargo module.

7. The modular cargo vehicle of claim 1, wherein the tow cycle is operable to be driven in:
a scooter mode in which the rider is supported on a standing surface of the tow cycle, and
a cycle mode in which the rider is supported on the rider seat to drive the modular cargo vehicle via the pedal crank.

8. The modular cargo vehicle of claim 1, wherein:
the front cargo module has a length that is at least twice as great as a length of the tow cycle, and/or
the trailer cargo module has a length that is at least twice as great as a length of the tow cycle, and/or
the cargo receiving area of the front cargo module has a length that is greater than a length of the tow cycle.

9. The modular cargo vehicle of claim 1, wherein the cargo vehicle is operable in a tow cycle solo mode, a tow cycle solo scooter mode, a tow cycle front cargo module mode, a tow cycle front cargo module scooter mode, a tow cycle trailer cargo module mode, a tow cycle trailer cargo module scooter mode, a tow cycle front cargo module and trailer cargo module mode, and/or a tow cycle front cargo module and trailer cargo module scooter mode.

10. A modular cargo vehicle, for transportation of cargo by a rider, the modular cargo vehicle comprising:
a tow cycle having a rider seat, a front axle with a front wheel, a rear axle with two rear wheels, and a pedal crank to facilitate driving of the tow cycle by the rider via a pedal crank;
a front cargo module operatively connected to the tow cycle such that a rear end of the front cargo module is coupled to a front end of the tow cycle, the front cargo module having a front axle with a front wheel, a cargo-receiving area, and no rear axle; and
a trailer cargo module operatively connected to the tow cycle such that a front end of the trailer cargo module is coupled to a rear end of the tow cycle, the trailer cargo module having a cargo-receiving area and an axially central axle with two wheels.

11. The modular cargo vehicle of claim 10, wherein in an operating mode of the modular cargo vehicle in which the front cargo module is coupled to the tow cycle:
the front wheel of the front axle of the tow cycle is not in contact with a support surface, and
the rear axle of the tow cycle is driven via the pedal crank.

12. The modular cargo vehicle of claim 10, wherein in an operating mode of the modular cargo vehicle in which the front cargo module is coupled to the tow cycle:
the rear wheel of the rear axle of the tow cycle is not in contact with a support surface, and
the front axle of the tow cycle is driven via the pedal crank.

13. The modular cargo vehicle of claim 10, wherein the tow cycle further has a drive battery and an electric drive motor to drive the front axle or the rear axle.

14. The modular cargo vehicle of claim 10, wherein the front cargo module further has a drive battery and an electric drive motor to drive the front axle of the front cargo module.

15. The modular cargo vehicle of claim 10, wherein the trailer cargo module has a drive battery and an electric drive motor to drive the axially central axle of the trailer cargo module.

16. The modular cargo vehicle of claim 10, wherein the tow cycle is operable to be driven in:
a scooter mode in which the rider is supported on a standing surface of the tow cycle, and
a cycle mode in which the rider is supported on the rider seat to drive the modular cargo vehicle via the pedal crank.

17. The modular cargo vehicle of claim 10, wherein:
the front cargo module has a length that is at least twice as great as a length of the tow cycle, and/or
the trailer cargo module has a length that is at least twice as great as a length of the tow cycle, and/or
the cargo receiving area of the front cargo module has a length that is greater than a length of the tow cycle.

18. The modular cargo vehicle of claim 10, wherein the cargo vehicle is operable in a tow cycle solo mode, a tow cycle solo scooter mode, a tow cycle front cargo module mode, a tow cycle front cargo module scooter mode, a tow cycle trailer cargo module mode, a tow cycle trailer cargo module scooter mode, a tow cycle front cargo module and trailer cargo module mode, and/or a tow cycle front cargo module and trailer cargo module scooter mode.

19. A modular cargo vehicle, for transportation of cargo by a rider, the modular cargo vehicle comprising:
a tow cycle having a rider seat, a front axle with a front wheel, a rear axle with two rear wheels, a pedal crank to facilitate driving of the tow cycle by the rider via a pedal crank, and standing surface to support the rider during operation of the modular cargo vehicle;
a front cargo module operatively connected to the tow cycle such that a rear end of the front cargo module is coupled to a front end of the tow cycle, the front cargo module having a front axle with a front wheel, a cargo-receiving area, and no rear axle; and
a trailer cargo module operatively connected to the tow cycle such that a front end of the trailer cargo module is coupled to a rear end of the tow cycle, the trailer cargo module having a cargo-receiving area and an axially central axle with two wheels.

20. The modular cargo vehicle of claim 19, wherein the tow cycle is operable to be driven in:
a scooter mode in which the rider is supported on a standing surface of the tow cycle, and
a cycle mode in which the rider is supported on the rider seat to drive the modular cargo vehicle via the pedal crank.
